(19) United States
(12) Patent Application Publication
(10) Pub. No.: US 2008/0225635 A1
(43) Pub. Date: Sep. 18, 2008

(54) Device for Adding a Powdery or Granulated Liquid-Soluble Polymer Flocculation Aid to a Liquid

(75) Inventors: Margot Reichmann-Schurr, Baden-Baden (DE); Hans Damm, Iffezheim (DE)

Correspondence Address: EGBERT LAW OFFICES, 412 MAIN STREET, 7TH FLOOR, HOUSTON, TX, 77002, US

(73) Assignee: Margot Reichmann-Schurr, Baden-Baden (DE)

(21) Appl. No.: 11/719,371

(22) PCT Filed: Nov. 12, 2005
(86) PCT No.: PCT/EP2005/012137

§ 371 Date: Jul. 1, 2007

(30) Foreign Application Priority Data
Nov. 15, 2004 (DE) 10 2004 055 072.7

(51) Int. Cl. B01F 3/12; G05D 11/02; B01F 5/04; G05D 11/04

(52) U.S. Cl. 366/152.1; 222/58; 222/59; 222/61; 366/167.1; 366/152.6

(57) ABSTRACT

The invention relates to a device for adding a powdery or granulated flocculation aid to a liquid. The device includes a container for receiving the flocculation aid to be added, the flocculation aid being mixed with a liquid by a controllable dosing element. The device is provided with scales for determining the weight of the flocculation aid to be supplied by the dosing element, and the quantity of flocculation aid is adapted to the quantity of liquid flowing through by a control system. A rotor-stator arrangement has a plurality of perforated disks arranged downstream from each other in the axial direction, used for the final reliable dissolution of the flocculation aid in the liquid.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention concerns a device for the metered addition of a powdery or granulated liquid-soluble flocculation aid to a liquid.

2. Description of Related Art Including Information Disclosed Under 37 CFR 1.97 and 37 CFR 1.98

In sewage treatment technology, muddy water that still contains up to 5% solids is treated with a liquid (preferably water) containing a dissolved flocculation aid. These flocculation aids are in particular synthetic polymers based on acrylamide, acrylic acid, and methacrylic acid as well as their esters. But on rare occasions even natural polymers such as starch, guar or behen seeds are used. In combination with inorganic precipitating agents, these polymers act as flocculation aids. Solids adhere to these flocculation aids and can then be precipitated more easily.

Such flocculation aids are made available in the form of granulates where a polymer gel, formed after polymerization in a watery monomer solution, is crumbled, dried, grounded and graded, or also in the form of pearl polymeride which is created by inverse suspension-polymerization. In this case a watery monomer solution is diffused in a non-miscible solvent (e.g. cyclohexan) and polymerized. The polymer is then separated from the solvent as a finished pearl.

It is also known that such flocculation aids are commercialized as emulsion polymerides. For these the watery monomer solution is emulsified in a non-miscible carrier (e.g. Isoparaffin) and polymerized. The carrier and the emulsifying agents remain in the product. This fact has disadvantages with respect to the cost structure of this product. Not only are the carriers relatively expensive but the carriers remaining in the product have also a negative effect, on transportation costs, due to their volumes and their weights.

Under this aspect the distinct preference is to use dry, granular, pearl shaped or powdery flocculation aids.

For producing a fluid diffused with such flocculation aids, it has been customary to manually add the flocculation aids which are shipped in bags or drums to a fluid that is present in an anticipated quantity in a tank and then to dissolve the flocculation aids in the fluid by means of a mixer-settler.

Alternatively it is also known to add such flocculation aids by means of a screw conveyor or similar from the top into a fluid and then to dissolve the flocculation aid, again by means of a mixer-settler. This mixer-settler may either be mounted permanently in the tank or may be inserted into the tank as an external stirring device for dissolving the flocculation aid.

What is problematic with these methods is that the dosages made with the methods described above are relatively imprecise. The method described first is also relatively cumbersome because of the manual handling of the flocculation aid. In addition, the subsequent dissolution by means of the mixer-settler is relatively tedious and inefficient.

As a matter of fact it has been found that with these kinds of apportioning between 20% and 50% of the added flocculation aids cause lumps in the fluid which it is then impossible to dissolve.

In this manner, any cost advantages, that are in principle present in the flocculation aids that are commercialized in dry form, are eaten up, as these flocculation aids are then usually added in higher doses so as to compensate for the poor dissolution.

It is therefore the aim of the present invention to indicate a device which makes it possible to achieve a more efficient proportioning of flocculation aids available in dry form, while also achieving a more precise dosage and facilitating their handling.

### BRIEF SUMMARY OF THE INVENTION

According to the invention, this aim is achieved by the fact that the device for the dosed addition of powdery or granular liquid-soluble flocculation aids features a compressed air duct for conveying the flocculation aid to the fluid.

The invention is based on the realization that the powdery or granulated flocculation aid can be dissolved in the fluid with far fewer problems when the particles are moistened individually with the fluid. This is achieved by injecting or blowing the flocculation aid with compressed air into the fluid. This prevents lumping of the flocculation aid in the fluid which then does not completely dissolve.

Although it would essentially be sufficient to inject the flocculation aid in the described manner into a tank filled with fluid it is preferred that the compressed air duct is discharged into a pipe through which the fluid is flowing into which the flocculation aid is to be added. In this way a particularly precise proportioning can be achieved.

In a particularly preferred execution of the design, such a device for the dosage-controlled addition of a powdery or granular liquid-soluble flocculation aid into a fluid features a container to be filled with the flocculation aid to be added and which, through the in-line arrangement of a controllable dosing element, is connected to the pipe through which the liquid flows. A flow-meter is associated with this pipe through the liquid flows. Furthermore, there are scales present which determine the weight of the flocculation aid dispensed by the dosing element, with both the scales as well as the aforementioned flow-meter emitting signals to a control, which, in reaction to these signals, affects the dosing element to which it is functionally connected for this purpose.

The further development has the advantage that it offers a particularly reliable and precise dosing and addition of a flocculation aid by mechanical means where, especially due to providing some scales, it is possible to ensure the required precision here too, because it allows compensating for any differences in density in the flocculation aid.

It has been shown to be advantageous to couple the scales with the container holding the flocculation aid to be added, so that they may then emit signals as a function of the weight reduction sustained by this container. This construction achieves a solution which can be realized with proven structural means.

The dosing element provided preferably features a controllable rotating drivable star feeder. This star feeder, which resembles a gearwheel in its appearance, makes it possible to dose the flocculation aid with great precision.

Here, it has been shown to be advantageous to provide the star feeder at its circumference with teeth that essentially end in lines. In this manner, the friction between the star feeder and the close-fitting wall of a chamber of the dosing element is reduced as much as possible.

As mentioned before, the star feeder is mounted in the dosing element in a chamber which surrounds the star feeder on its flat sides and at its circumference with walls. In the wall surrounding the star feeder at its circumference, a feeding orifice is provided which is connected to the container for holding the flocculation aid to be added. This feeding orifice is formed in axial direction of the star feeder to be shorter than the star feeder and is mounted above it, approximately symmetrically to a center plane of the vertically placed star feeder. In this way the flocculation aid, that is transported through the feeding orifice to the star feeder, is supplied to the star feeder essentially at its center and thus does not produce any undesirable friction effects on the faces of the star feeder.

Advantageously, the wall surrounding the star feeder on its circumference is provided with a recess widening in radial direction, positioned in the rotation direction of the star feeder downstream of the feeder orifice. In a certain way, this leads to a loosening of the flocculation aid, thus making it easier to convey and to dose it.

The purpose is to make the compressed air, to which the flocculation aid has been added, flow through the dosing element in the area of the recess. The compressed air, to which the flocculation aid has been added, is then injected, as described above, into a liquid, and it is suggested that this mixture containing liquid, (compressed) air and flocculation aid be fed into a mixing chamber where the added flocculation aid is then going to be dissolved in the liquid.

In a particularly preferred form of execution, a rotor-stator arrangement is provided with the stator being equipped with a large number of perforated disks that are positioned parallel to each other in axial direction and through which the liquid is to flow. Between such perforated disks, a worm or propeller-shaped portion of the rotor is positioned which ensures continuous transportation of the mixture of liquid and flocculation aid.

With this construction, it has been shown to be very effective to gradually reduce the diameter of the holes in the perforated disks as they are arranged in the downstream direction. This results in an especially rapid and efficient dissolution of the flocculation aid in the liquid.

It should also be mentioned that an air separator is provided on the device as described here whereby the air which helps to add the flocculation air to the liquid, is being separated.

### BRIEF DESCRIPTION OF THE SEVERAL VIEWS OF THE DRAWINGS

Additional advantages and characteristics of the invention become apparent in the following description of an example execution of the invention.

FIG. 1 shows a perspective view of a device according to the invention.

FIG. 2 shows a cross-sectional view through a container for the reception of the flocculation aid to be added.

FIG. 3 is an exploded perspective view of the scales positioned in the device.

FIG. 4 is a perspective view of a representation of a partially disassembled dosing element.

FIG. 5 is another perspective view of part of the dosing element according to the invention.

FIG. 6 is a cross-sectional view of the part shown in FIG. 5.

FIG. 7 shows a cross-sectional view through a component of the device for the injection of flocculation aid into a liquid.

FIG. 8 is another cross-sectional view through a rotor-stator device of the device according to the invention.

FIG. 9 is a perspective view of a perforated disk from the rotor-stator device according to FIG. 8.

### DETAILED DESCRIPTION OF THE INVENTION

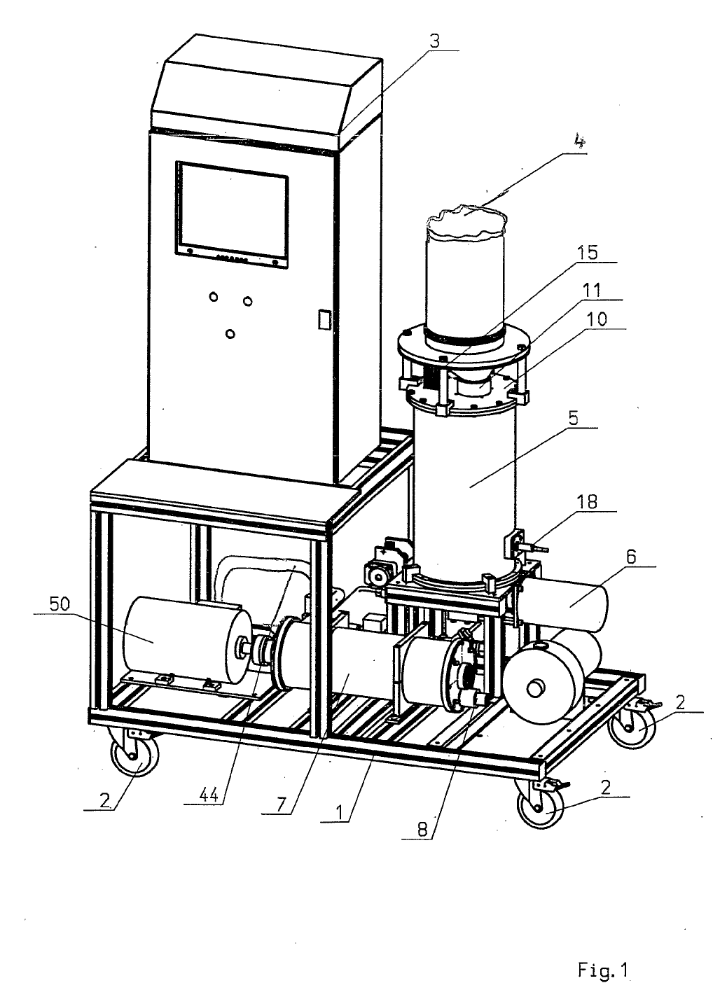

FIG. 1 shows the construction of a device according to the invention, being a compact, portable version.

On a base plate 1 with several casters 2, the device according to the invention is mounted, and the controls provided for the device are in a separate cabinet 3.

The device according to the invention is filled through a pipe joint 4 or an appropriate funnel with a liquid-soluble flocculation aid which is received in a container 5.

From this container 5, this flocculation aid, which is powdery or granular and which is in particular a polymer, is then removed through a dosing element 6 and added to a liquid. This liquid mixed with the flocculation aid is directed through a rotor-stator device 7 in which the flocculation aid is dissolved in the liquid. The liquid with the dissolved flocculation aid is then dispensed, over a connection piece 8 and a duct that is not shown, from the device and is added in a sewage treatment plant to a sludge liquor containing up to approximately 5% solids. The dissolved flocculation aids bond with these solids which leads to their precipitation.

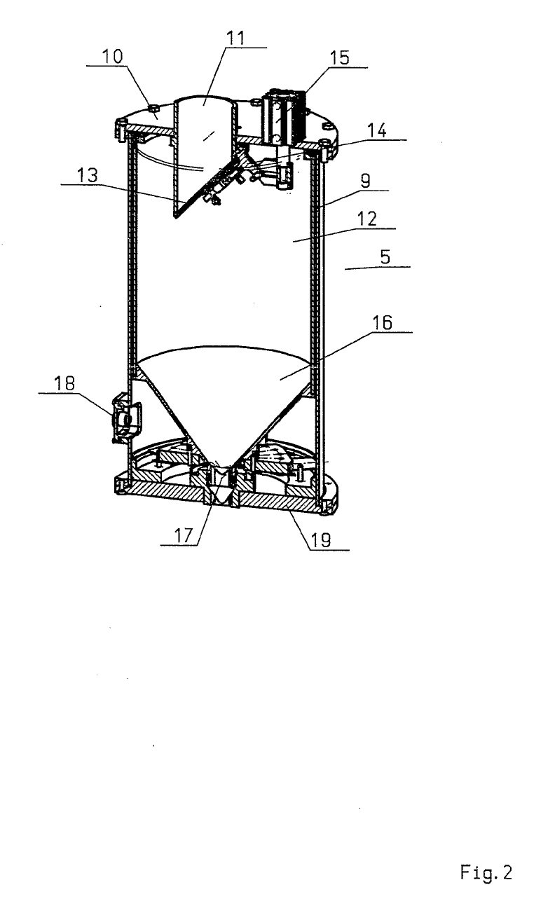

The container 5 is shown in FIG. 2 as a sectional view. A cylindrical wall 9 can be identified, which is closed off at its upper end by a cover 10. Integrated into this cover 19 is a drop shaft 11 through which the powdery or granular liquid-soluble flocculation aid is able to reach the interior 12 of the container 5. The drop shaft 11 can be closed at its lower end by means of a swing cover 13 which can be actuated by a rocking lever mechanism 14 controlled by a pneumatic cylinder 15.

In the interior 12 of the container 5, opposite the cover 10 with the drop shaft 11, a funnel-shaped bottom 16 is positioned which terminates in a centric discharge opening 17.

Furthermore, there is, in the wall 9 of the container 5, a compressed-air valve 18 whose function is explained in more detail below.

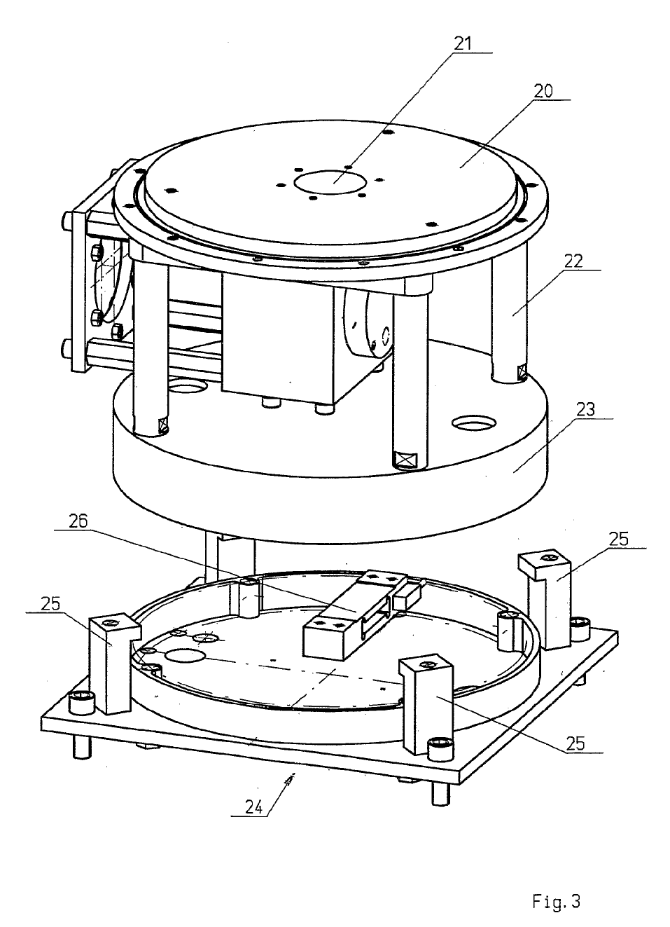

The container 5, shown in FIG. 2, is mounted on a weighing platform as shown in FIG. 3 as an example. The bottom 18 of the container 5 is here seated on a supporting plate 20 which has a central opening 21, above which the discharge opening 17 is positioned. The supporting plate 20, spaced by posts 22, is borne by a weighing tray 23 which rests on a scale base 24. The weighing tray 23 is guided by guide clamps 25. The travel path of the weighing tray 23 is registered by a weighing element 26 and then transmitted to the control in the cabinet 3.

Here again the function will be explained below in more detail.

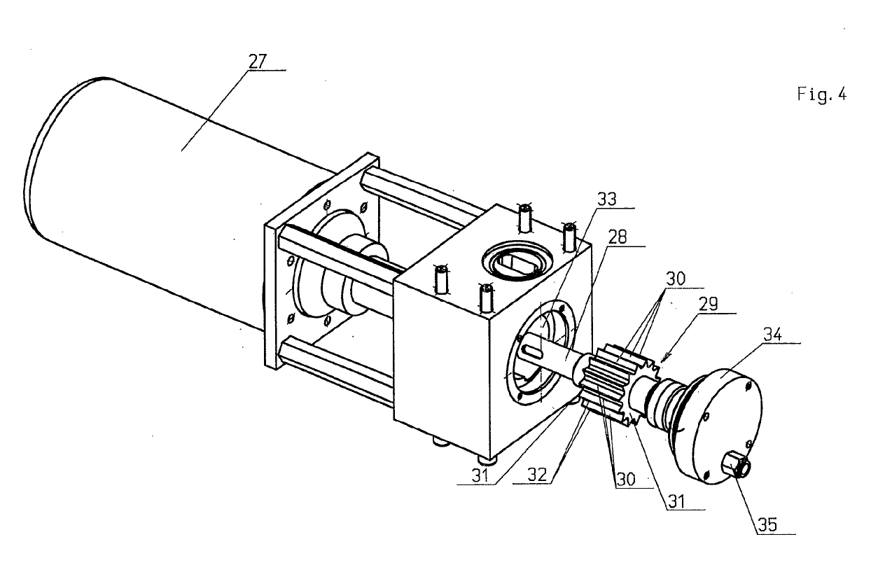

In the space created by the posts 22 between the supporting plate 20 and the weighing tray 23, a dosing element is positioned, which is shown in more detail in FIG. 4 in a partially exploded view.

In this dosing element, a motor 27, that is controllable by the control 3, drives an essentially horizontal shaft 28 on which a vertically driven star feeder 29 is mounted in a torsion-proof manner. This star feeder 29 has, over its circumference, a large number of cells 30 running parallel to the axis and which are open to the faces of the star feeder 29. The cells form teeth between them which terminate in lines 32 at the exterior circumference of the star feeder.

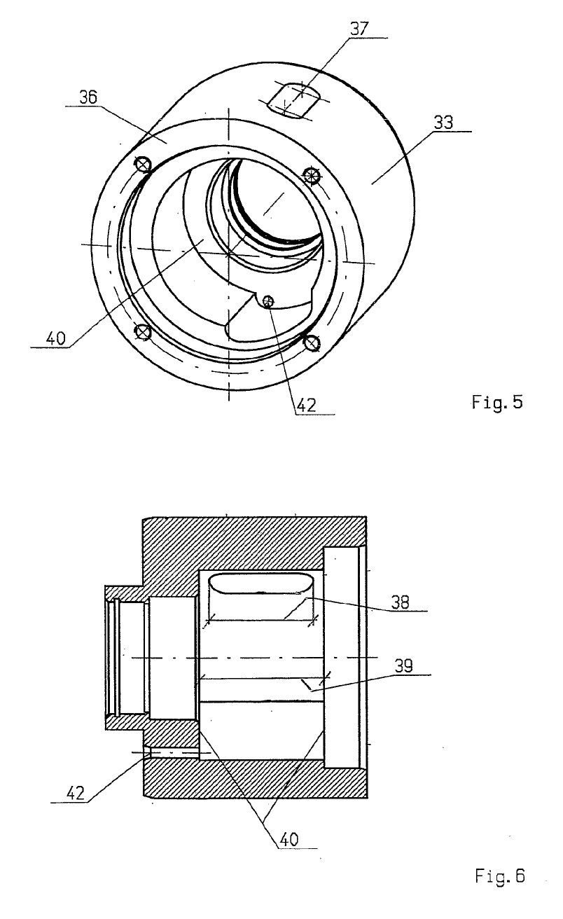

The star feeder 29 rotates in a chamber 33, which is made as an interchangeable element in the present example and which is shown in greater detail in FIGS. 5 and 6. This chamber 33 can be closed by a cover 34 which features a connector 35 where compressed air is able to exit from the chamber 33, this compressed air flowing through the chamber 33, as described below, parallel to the axis of the star feeder.

As stated earlier, the chamber 33 is shown in greater detail in FIGS. 5 and 6. In FIG. 5, the chamber 33 is seen in its usual operating position, with the shaft of the star feeder 29 rotating inside it being essentially in a horizontal position.

In the example represented here, the star feeder will be turning in a clockwise sense of rotation.

In the direction of the rotation shortly past the uppermost vertex of the chamber, an input orifice 37 is located which goes through the wall 36 in a vertical direction and ends inside the chamber 33. The axial extension 38 of this input orifice is, as visible in FIG. 6, shorter than the distance 39 between the side walls 40 of the chamber 33 which are located parallel to the faces 31 of the star feeder 29. This has the effect that any material falling through the input orifice 37 does not get deposited between the side walls 40 of the chamber 33 and the faces 31 of the star feeder 29, because this would lead to blocking or slowing down the rotating star feeder.

FIG. 5 also shows that the wall 36 of chamber 33 is surrounding the star feeder at its circumference, featuring, downstream of the input orifice 37 in the rotational direction of the star feeder, a recess 41 extending in the radial direction. This recess prevents any material that may, because of gravity, fall out of the cells of the star feeder 29 from becoming stuck between the lines 32 at the circumference of the star feeder 29 and the wall 36.

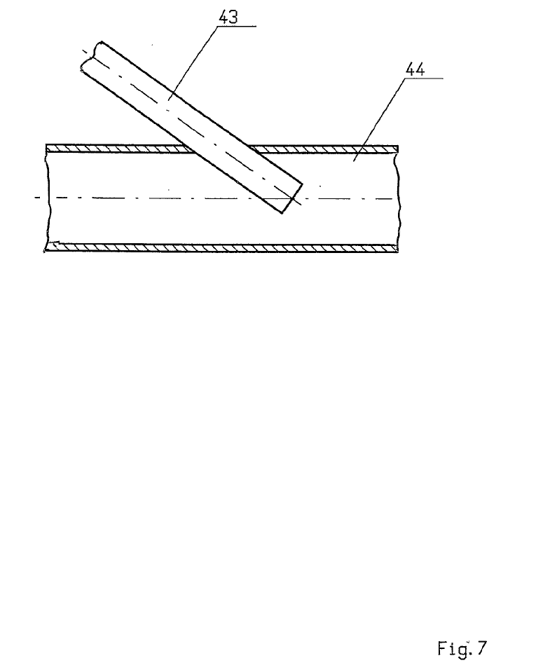

In this recess 41, the compressed air admitted through the connector 42 parallel to the axis is guided through the cells 30 of the star feeder 29 and is then evacuated from the chamber 33 through the connector 35. This compressed air carries along with it the powdery or granular flocculation aid that has been supplied to the dosing element and transports it to a component represented in FIG. 7.

In this component, the compressed air, enriched with the flocculation aid, is blown by an injector into a liquid which flows through a duct 33 (to the right in FIG. 7). The angle of inclination between the injector 43 and the liquid-carrying duct 44 is preferably in the range of 45 degrees or less, in order to obtain a good blend.

In particular, during this injection, the powdery or granular flocculation aid is introduced into the duct 44 in such a manner that each individual particle is enveloped by the liquid and thus becomes moistened. Lumping of the flocculation aid is effectively prevented in this manner.

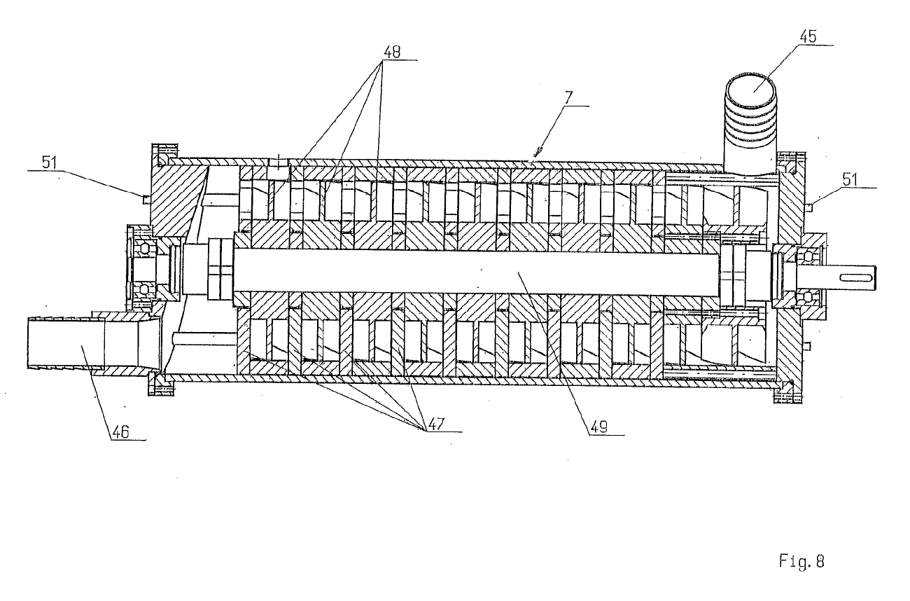

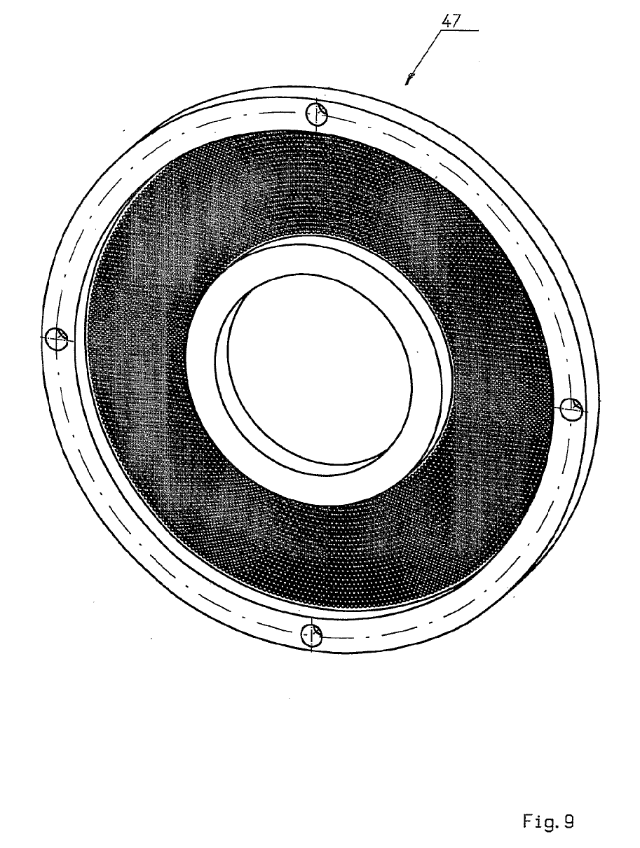

In the duct 44, the blend of liquid, flocculation aid and air is brought to the mixing device 7 which contains a rotor-stator device and which is shown in FIG. 8.

From an input orifice 44 located in tangential direction to the right, the flow, through the rotor-stator device shown in FIG. 8, occurs essentially in axial direction towards an output orifice 46 located in axial direction at the axially opposite end.

The liquid flowing through the rotor-stator device passes alternately through fixed perforated disks 47 and through spaces where it is conveyed through propeller or worm sections in the axial direction. The propeller or worm sections are mounted on a common drive shaft 49 which is put into rotating motion by a motor 50 shown in FIG. 1.

The individual perforated disks 47, of which one is shown in FIG. 9, feature, in their radial middle area, a large number of holes parallel to the axis. These holes become smaller and smaller in subsequent perforated disks, so that a dissolution of the flocculation aid is achieved in the flowing liquid.

The device described so far is now put into operation as follows:

Upon opening of the swing cover 13, the container 5 is filled through the drop shaft 11 with a preset quantity of powdery or granular flocculation aid. Then, the swing cover 13 above the pneumatic cylinder 15 is closed again, and, in the interior 12 of the container 5, a pressure of approximately 5 bar is built up by means of the compressed air valve.

The flocculation aid contained in the container 5 now trickles through the discharge opening 17 and through the opening 21 in the supporting plate 20 into the opening 37 of the mixing chamber 33 and falls here onto the star feeder 29. This star feeder rotates and thereby doses the flocculation aid that is being conveyed by the compressed air which is being conducted by means of the connector 42 and the connector 35 through the chamber 33 in axial direction. The blend exiting from the chamber 33 thus consists of flocculation aid and air.

The compressed air is under about 5 bars of pressure as it is built up in the container 5. Therefore no pressure differentials need to be overcome inside the mixing chamber 33.

This compressed air enriched with flocculation aid is then being conveyed, as described, to the component as per FIG. 7 and is here being injected into the liquid that is flowing through duct 44.

This incoming liquid is being captured, prior to being subjected to the injection of the mixture of compressed air and flocculation aid by a (not represented) flow meter and this measured quantity is being transmitted to the control installed in the cabinet 3.

The quantity of flocculation aid added to the flowing liquid by the dosing element 6 is being captured by the weight loss experienced over time by the container 5 and measured by the weighing element 26 in the scale base 24. It must here be assumed that the weight of the elements captured by the weighing element 26 remains constant with the exception of the flocculation aid present in the interior 12 of the container 5.

Depending on the weight loss and the measured flow-through quantity, the control 3 then determines especially the speed of the motor 27, in order to effect in this manner a reduction of the flocculation aid that is proportional to the flow-through quantity, so that it can be assumed that a preset quantity of flocculation aid is always added into the liquid which reaches the mixing device 7.

As described, the dissolution of this flocculation aid in the liquid then takes place in the rotor-stator device 7 where there is also, coupled in parallel to it, an air separator, in order to separate the air originating in the interior 12 of the container 5, and also the compressed air that was used for the injection from the mixture of liquid and flocculation aid.

This liquid-cum-flocculation aid is then added, as described above, in a sewage treatment plant to the muddy water containing solids for the purpose of purifying it further.

It should also be mentioned that it is also possible to add an additional liquid flocculation aid in the rotor-stator device 7. In this case, it is to be taken into consideration that powdery or granular flocculation aids in connection with such liquid flocculation aids present flocculation qualities that are especially advantageous because they are widely diversified.

The addition of such flocculation aids that are available in liquid form may be done in the described rotor-stator device either during the first pass-through for the dissolution of powdery or granular flocculation aids in a liquid or during a successive second circulation of the already existing liquid through the rotor-stator device 7.

The advantage of the device described here rests especially in the possibility of a quasi-continuous production of a mixture of flocculation aid and liquid and its specific operational safety.

1. Device for dosed addition of a powdery or granular liquid-soluble flocculation aid in a liquid, said device comprising:
a compressed air pipe, conveying the flocculation aid to said liquid.

2. Device in accordance with claim 1, wherein said compressed air pipe discharges into a duct conveying said liquid.

3. Device according to claim 2, further comprising:
a controllable dosing element connected to said compressed air pipe and a container receiving the flocculation aid to be added, said duct conveying the liquid having a flow-meter with a weighing device determining weight of the flocculation aid dispensed by the dosing element, said flow-meter and said weighing device transmitting signals and being connected to a control being dependent upon the signals and being functional connected to the dosing element.

4. Device according to claim 3, wherein said weighing device is coupled to said container, transmitting signals according to weight loss of said container.

5. Device according to claim 3, wherein the dosing element is comprised of a controllable rotating drivable star feeder.

6. Device according to claim 5, wherein the star feeder has a plurality of cells ending in lines and being arranged at a circumference of the star feeder.

7. Device according to claim 5, wherein the star feeder is mounted in the dosing device in a chamber of the dosing device, said chamber surrounding faces of the star feeder, said chamber having a first wall and a second wall, each wall with a circumference, said first wall surrounding the star feeder within said circumference of said first wall, said chamber having an input orifice provided in an axial direction of the star feeder in said first wall.

8. Device according to claim 7, wherein said first wall surrounding the star feeder has a recess expanded in a radial direction, placed after said input orifice in a rotational direction of the star feeder.

9. Device according to claim 8, wherein said recess has an area for flow of compressed air in an axial direction.

10. Device according to claim 3, further comprising:
a mixing device positioned with a rotor-stator arrangement after said duct and within a flow direction of said duct.

11. Device according to claim 10, wherein said rotor-stator arrangement is comprised of a plurality of perforated disks for a through-flow in an axial direction.

12. Device according to claim 11, wherein each perforated disk has a successive diameter decreasing in a downstream direction.

13. Device according to claim 10, wherein said mixing device is comprised of an air separator.
